(19) United States
(12) Patent Application Publication
(10) Pub. No.: US 2016/0135435 A1
(43) Pub. Date: May 19, 2016

(54) Nutrient Enriched Mineral Substrate for Propagating Marine Life

(71) Applicants: Thomas Manning, Hahira, GA (US); Brittany Butler, Ray City, GA (US); Mehulkumar Patel, Valdosta, GA (US); Sydney Plummer, Quitman, GA (US); Tess Baker, Valdosta, GA (US)

(72) Inventors: Thomas Manning, Hahira, GA (US); Brittany Butler, Ray City, GA (US); Mehulkumar Patel, Valdosta, GA (US); Sydney Plummer, Quitman, GA (US); Tess Baker, Valdosta, GA (US)

(73) Assignee: Valdosta State University, University System of Georgia, Valdosta, GA (US)

(21) Appl. No.: 14/540,341

(22) Filed: Nov. 13, 2014

(51) Int. Cl. A01K 61/00

(52) U.S. Cl. CPC A01K 61/006

(57) ABSTRACT

Many types of artificial reefs have been deployed in the world's oceans, bays and estuaries. These range from sinking ships to dispersing old building debris. In most approaches, the material placed in the marine environment lacks any nutrients needed for growth or concern regarding proper chemical conditions necessary to start and sustain life. In this discovery, concrete is made from both inorganic and organic components. The inorganic components are selected to include species that will be used to create a receptive surface to start and sustain life. Moreover, other conditions such as pH, chemical toxicity, nutrient levels and biodegradability are considered in the formulation. Additionally, there is an organic component that is part of the concentration mixture which provides trace nutrients and serves to weaken the structures so it will biodegrade over time. The biodegradable concrete slowly releases small quantities of resources (over months and years) providing a steady flux of essential nutrients.

### RELATED APPLICATIONS

| Patent # | Issued date | Inventor | Title |
|---|---|---|---|
| U.S. Pat. No. 2,017,090 | 15 Oct. 1935 | Jr William | Fertilizer and method of |
| | | Eggert | fertilizing |
| U.S. Pat. No. 3,155,609 | 3 Nov. 1964 | Pampel | Stabilization of a closed or |
| | | Leonard | open water system through the |
| | | Fredrick | selective utilization of light |
| U.S. Pat. No. 3,238,279 | 1 Mar. 1966 | Tarlton John | Method for curing concrete |
| | | | products |
| U.S. Pat. No. 3,572,292 | 23 Mar. 1971 | Canadian | Artificial oyster clutches |
| | | Patents Dev | |
| U.S. Pat. No. 4,047,962 | 13 Sep. 1977 | Copeland | Construction composition |
| | | Concrete | |
| | | Products Inc. | |
| U.S. Pat. No. 4,080,929 | 28 Mar. 1978 | Millnitz | Method and apparatus for |
| | | Ronald | brooding fish |
| U.S. Pat. No. 4,395,970 | 2 Aug. 1983 | Kunkle Arthur | Open clean habitat for shell |
| | | | fish |
| U.S. Pat. No. 4,594,965 | 17 Jun. 1986 | Asher Jr | Marine husbandry system |
| | | Donald | |
| U.S. Pat. No. 4,468,885 | 4 Sep. 1984 | Mandish | Hydroponic system with |
| | | Theodore | floating plant trays and precast |
| | | | concrete sidewalls |
| U.S. Pat. No. 4,843,112 | 27 Jun. 1989 | Beth Israel | Bio-erodible implant |
| | | Hospital | composition |
| | | Assoc. | |
| U.S. Pat. No. 4,788,937 | 6 Dec. 1988 | Keyser George | Oyster bed fostering |
| U.S. Pat. No. 4,903,636 | 27 Feb. 1990 | James Kroeker | Artificial habitat for aquatic |
| | | | animals |
| U.S. Pat. No. 4,844,015 | 4 Jul. 1989 | Univ Of | Artificial oyster cultch |
| | | Delaware | |
| U.S. Pat. No. 4,996,943 | 5 Mar. 1991 | Univ Of | Process for preparing cultch for |
| | | Delaware | Mollusca |
| U.S. Pat. No. 4,997,311 | 5 Mar. 1991 | Doren David | Artificial reef |
| | | Van | |
| U.S. Pat. No. 5,579,724 | 3 Dec. 1996 | Chauvin; | Oyster holder for oyster |
| | | Leroy | growing system |
| U.S. Pat. No. 6,036,933 | 14 Mar. 2000 | Pretoria | Calcium carbonate |
| | | Portland | precipitation method |
| | | Cement Comp. | |
| | | Ltd | |
| U.S. Pat. No. 5,803,660 | 8 Sep. 1998 | Warren; | Integrated reef building system |
| | | Donald | |
| U.S. Pat. No. 5,704,313 | 6 Jan. 1998 | Gibbs; | Rotating aquarium |
| | | Mitchell | |
| U.S. Pat. No. 5,836,265 | 17 Nov. 1998 | Barber; Todd | Reef ball |
| | | Ryan | |
| U.S. Pat. No. 5,782,204 | 21 Jul. 1998 | Tidaltronics | Wavemaker for living |
| | | Inc. | aquariums |
| U.S. Pat. No. 5,921,203 | 13 Jul. 1999 | Gibbs; | Rotating aquarium |
| | | Mitchell | |
| U.S. Pat. No. 5,967,088 | 19 Oct. 1999 | Lin; Hsi-Chun | Watertight plug structure for an |
| | | | aquarium |
| U.S. Pat. No. 6,264,736 | 24 Jul. 2001 | Board of | Pressure-assisted molding and |
| | | Supervisors of | carbonation of cementitious |
| | | LSU and | materials |
| | | Agricultural | |
| | | and Mech. | |
| | | College | |
| U.S. Pat. No. 6,520,116 | 18 Feb. 2003 | Penn Cove | Method and apparatus for |
| | | Shellfish Llc | supporting aquacultured |
| | | | mussels |
| U.S. Pat. No. 6,467,993 | 22 Oct. 2002 | Philip Utter | Fish attractive device |
| U.S. Pat. No. 6,539,894 | 1 Apr. 2003 | Eagle Net Sea | Aquaculture farm system and |
| | | Farms Inc. | method |
| U.S. Pat. No. 6,578,523 | 17 Jun. 2003 | Gilles Gagnon | Mussel cultivation device |
| U.S. Pat. No. 7,997,231 | 16 Aug. 2011 | Madelaine Joy | Composition suitable for |
| | | Fernandez | aquatic habitat repair, |
| | | | replacement and/or |
| | | | enhancement |
| U.S. Pat. No. 6,897,382 | 24 May 2005 | Neptco Jv Llc | High modulus fibers primarily |
| | | | surrounded by and encased by |
| | | | a saturant that fills the |
| | | | interstices between each fiber |
| | | | and having a melting point |
| | | | below 300 degrees Celsius and |
| | | | a melt viscosity of less than |
| | | | 1000 centipoise. |
| U.S. Pat. No. 6,896,445 | 24 May 2005 | Eric Engler | Modular artificial reef, sea wall |
| | | | and marine habitat |
| U.S. Pat. No. 6,962,130 | 8 Nov. 2005 | Kennedy | Garden pond shelter reef |
| | | James | |
| U.S. Pat. No. 7,285,238 | 23 Oct. 2007 | Reefmattes Llc | Reef artifact |
| US20060112895 | 1 Jun. 2006 | Laurent Olivier | System for raising aquatic |
| | | | animals |
| U.S. Pat. No. 7,144,196 | 5 Dec. 2006 | Ora | Biologically-dominated |
| | | Technologies | artificial reef |
| | | Llc | |
| U.S. Pat. No. 7,736,430 | 15 Jun. 2010 | William Marsh | Compositions and methods for |
| | | Rice Univ. | controlling the setting behavior |
| | | | of cement slurries using |
| | | | carbonated fly ash |
| U.S. Pat. No. 7,748,349 | 6 Jul. 2010 | Open Ocean | Submersible cage and system |
| | | Systems Inc. | for fish farming |
| US20080216757 | 11 Sep. 2008 | Kuo-Tang | Breeding tank |
| | | Tseng | |
| U.S. Pat. No. 7,827,937 | 9 Nov. 2010 | David Walter | Marine line form habitat |
| U.S. Pat. No. 7,735,274 | 15 Jun. 2010 | Calera Corp. | Hydraulic cements comprising |
| | | | carbonate compound |
| | | | compositions |
| US20090020044 | 22 Jan. 2009 | Constantz | Containing salt-water derived, |
| | | Brent | crystalline and/or amorphous |
| | | | carbonate such as aragonite; |
| | | | building, construction |
| | | | materials |
| U.S. Pat. No. 7,744,761 | 29 Jun. 2010 | Calera Corp. | Carbon dioxide sequestration; |
| | | | industrial waste gas streams |
| | | | from power plants; for |
| | | | construction materials, |
| | | | concrete, cements |
| US20090001020 | 1 Jan. 2009 | Constantz | Desalination methods and |
| | | Brent | systems that include carbonate |
| | | | compound precipitation |
| U.S. Pat. No. 8,006,645 | 30 Aug. 2011 | Spartz Karen | System and method for |
| | | | aquaculture of marine life |
| | | | forms |
| U.S. Pat. No. 7,790,012 | 7 Sep. 2010 | Calera Corp. | On applying a low voltage |
| | | | across the anode and cathode, |
| | | | OH− forms at the cathode and |
| | | | protons form at the anode |
| | | | without Cl₂ or O₂ forming at |
| | | | the anode; depending on |
| | | | electrolytes used, NaOH, forms |
| | | | in 2ⁿd electrolyte in contact |
| | | | with cathode and HCl form in |
| | | | 1st electrolyte in contact with |
| | | | the anode |
| US20110036728 | 17 Feb. 2011 | Calera Corp. | Low-energy electrochemical |
| | | | proton transfer system and |
| | | | method |
| US20090169452 | 2 Jul. 2009 | Constantz | Methods of sequestering CO2 |
| | | Brent | |
| U.S. Pat. No. 7,753,618 | 13 Jul. 2010 | Calera Corp. | Rocks and aggregate, and |
| | | | methods of making and using |
| | | | the same |
| US20100024686 | 4 Feb. 2010 | Brent | Contacting a CO2 containing |
| | | Constantz | gaseous stream with a water to |
| | | | dissolve CO2, placing the |
| | | | water under precipitation |
| | | | conditions sufficient to |
| | | | produce a carbonate containing |
| | | | precipitate product(CaCO3, |
| | | | MgCO3 or calcium magnesium |
| | | | carbonate); CO2 sequestering; |
| | | | reducing golbal warming; |
| U.S. Pat. No. 7,754,169 | 13 Jul. 2010 | Calera Corp. | An aqueous solution of flue |
| | | | gas/combustion ash contacted |
| | | | with carbon dioxide; hydration |
| | | | of oxides to hydroxides; |
| | | | precipitated to provide calcite |
| | | | and magnesium carbonate; |
| | | | building material product for |
| | | | hydraulic cement, pozzolanic |
| | | | cement, and an aggregate; |
| | | | sulfur trioxide, NOX gas also |
| | | | used |
| US20100000444 | 7 Jan. 2010 | Brent | Methods and systems for |
| | | Constantz | utilizing waste sources of |
| | | | metal oxides |
| US20100319586 | 23 Dec. 2010 | Savannah | Carbon dioxide capture from a |
| | | River Nuclear | cement manufacturing process |
| | | Solutions, Llc | |
| U.S. Pat. No. 7,875,163 | 25 Jan. 2011 | Calera Corp. | Low-voltage, low-energy |
| | | | electrochemical system and |
| | | | method of producing |
| | | | hydroxide ions and/or |
| | | | bicarbonate ions and/or |
| | | | carbonate ions utilizing |
| | | | significantly less than the |
| | | | typical 3 V used across the |
| | | | conventional anode and |
| | | | cathode to produce the ions; |
| | | | reduced carbon dioxide |
| | | | emissions |
| U.S. Pat. No. 7,749,476 | 6 Jul. 2010 | Calera Corp. | Production of carbonate- |
| | | | containing compositions from |
| | | | material comprising metal |
| | | | silicates |
| US20100111810 | 6 May 2010 | Brent | Non-cementitious |
| | | Constantz | compositions comprising co2 |
| | | | sequestering additives |
| US20120055376 | 8 Mar. 2012 | Aalborg | Portland limestone calcined |
| | | Portland A/S | clay cement |
| US20100258035 | 14 Oct. 2010 | Brent | Compositions and methods |
| | | Constantz | using substances containing |
| | | | carbon |
| US20100313794 | 16 Dec. 2010 | Constantz | Production of carbonate- |
| | | Brent | containing compositions from |
| | | | material comprising metal |
| | | | silicates |
| US20100239467 | 23 Sep. 2010 | Brent | Methods and systems for |
| | | Constantz | utilizing waste sources of |
| | | | metal oxides |
| US20110067600 | 24 Mar. 2011 | Constantz | Methods and compositions |
| | | Brent | using calcium carbonate |
| US20110071309 | 24 Mar. 2011 | Constantz | Methods and Systems for |
| | | Brent | Utilization of HCI |
| US20110054084 | 3 Mar. 2011 | Constantz | Hydraulic cements comprising |
| | | Brent | carbonate compound |
| | | | compositions |
| U.S. Pat. No. 8,177,909 | 15 May 2012 | Calera Corp. | Methods and compositions |
| | | | using calcium carbonate |
| US20120031303 | 9 Feb. 2012 | Constantz | Calcium carbonate |
| | | Brent | compositions and methods |
| | | | thereof |
| US20110283929 | 24 Nov. 2011 | Stewart | Mooring structure with habitat |
| | | Hardison | features for marine animals |
| U.S. Pat. No. 8,267,045 | 18 Sep. 2012 | Spartz Karen | System and method for |
| | | | aquaculture of marine life |
| | | | forms |
| DE102010021606A1 | 24 Nov. 2011 | Stiftung | Vorrichtung zur |
| | | Alfred- | Habitaterschlieβung im |
| | | Wegener- | Unterwasserbereich eines |
| | | Institut Für | Offshore-Bauwerks |
| | | Polar-Und | |
| | | Meeresforschung | |
| DE102010021606B4 | 12 Apr. 2012 | Stiftung | Vorrichtung zur |
| | | Alfred- | Habitaterschlieβung im |
| | | Wegener- | Unterwasserbereich eines |
| | | Institut Für | Offshore-Bauwerks |
| | | Polar-Und | |
| | | Meeresforschung | |
| EP2253600A1 | 24 Nov. 2010 | Aalborg | Portland limestone calcined |
| | | Portland A/S | clay cement |
| EP2484650A1 | 8 Aug. 2012 | Egis Eau | Structure including a plurality |
| | | | of blocks of non-reinforced |
| | | | fibrous, shell-containing |
| | | | concrete and method for |
| | | | manufacturing such a structure |
| FR2627951A1 | 8 Sep. 1989 | Sermar Sa | Underwater farm for study of |
| | | | marine flora and fauna-is |
| | | | formed by concrete block with |
| | | | numerous holes and recesses |
| FR2858920A1 | 25 Feb. 2005 | Guilbaud | Oyster rearing procedure |
| | | Stephane | consists of attaching each one |
| | | Roger | to plastic mesh on bottom of |
| | | | maturing bed by blob or mortar |
| GB2061081A | 13 May 1981 | Highlands & | Shellfish culture |
| | | Islands Dev | |
| | | Board | |
| GB2421884A | 12 Jul. 2006 | Aurora Mar | C shaped pegs for attachment |
| | | Ltd | to ropes for shellfish |
| | | | cultivation |
| JP2000302500A | 31 Oct. 2000 | Sekisui | Active powder, cement |
| | | Chemical Co | composition, and hardened |
| | | Ltd | cement |
| JP2006025720A | 2 Feb. 2006 | Okabe Co Ltd | Structure for creating seaweed |
| | | | bed and method for creating |
| | | | seaweed bed by using the same |
| JP2006223297A | 31 Aug. 2006 | Sakata | Method for treating surface of |
| | | Yasunari | cement based cured product for |
| | | | adhesion of seaweed, raft |
| | | | method by underwater |
| | | | exposure of porous material |
| | | | bagged in net, hanging method, |
| | | | mat method, and fish or |
| | | | shellfish-living environment- |
| | | | maintaining method in |
| | | | seaweed bed or artificial |
| | | | fishing bank by these methods |
| JPH01179634A | 17 Jul. 1989 | Itokawa Koyo; | Man-made gathering place for |
| | | Aso Toshio | seaweed of water permeable |
| | | | concrete |
| JPH0598654A | 20 Apr. 1993 | Raito Kogyo; | Concrete block for greening |
| | | Nihon Cement; | |
| | | Nittoc | |
| | | Construction; | |
| | | Fuji Concrete | |
| | | Kogyo; Kyowa | |
| | | Concrete | |
| | | Kogyo | |
| JP2000178057A | 27 Jun. 2000 | Shimizu | Vegetation concrete and its |
| | | Construction | production |
| | | Co Ltd | |
| NZ511126A | 28 Sep. 2001 | Searl Seafoods | Shellfish aquaculture method |
| | | PTY LTD | and apparatus with platform |
| | | | located above sea bed and |
| | | | constructed to retain support |
| | | | blocks |
| NZ531711A | 25 Jun. 2004 | MOLLUSC | A method of tagging a shellfish |
| | | PTY LTD | and a detectable shellfish |
| | | | produced by such a method by |
| | | | incorporating tag into shell as |
| | | | shellfish grows |
| WO2001019180A1 | 22 Mar. 2001 | Hajime | Seaweed field forming material |
| | | Kobayashi | and its block |
| WO2004031096A1 | 15 Apr. 2004 | Madelaine Joy | Composition suitable for |
| | | Fernandez | aquatic habitat repair, |
| | | | replacement and/or |
| | | | enhancement |
| WO2010039909A1 | 8 Apr. 2010 | Calera Corp. | Compositions and methods |
| | | | using substances containing |
| | | | carbon |
| WO2010048457A1 | 29 Apr. 2010 | Calera Corp. | Reduced-carbon footprint |
| | | | concrete compositions |
| WO2010051458A1 | 6 May 2010 | Calera Corp. | Non-cementitious |
| | | | compositions comprising CO₂ |
| | | | sequestering additives |
| WO2011079346A1 | 7 Jul. 2011 | Samuel | Artificial marine habitat |
| | | Bennett | |
| WO2011147400A2 | 1 Dec. 2011 | Stiftung | Device for developing habitats |
| | | Alfred- | in the underwater area of an |
| | | Wegener- | offshore construction |
| | | Institut Für | |
| | | Polar-Und | |
| | | Meeresforschung | |

### Journal Articles Cited

Wilker, J. 2011. Biomaterials: redox and adhesion on the rocks. Nature Chemical Biology, 7: 579-580.
Anthony, K. 2006. Enhanced energy status of corals on coastal, high-turbidity reefs. Marine Ecology Progress Series, 319: 111-116.
Stephens, G. 1960. Uptake of glucose from solution by the solitary coral. Fungia Science, 131: 1532-1532.
Stephens, G. 1962. Uptake of organic material by aquatic invertebrates I. Uptake of glucose by the solitary coral, Fungia scutaria. Biological Bulletin, 123: 648-659.
Stephens, G. and Schinske, R. 1961. Uptake of amino acids by invertebrates. Limnology & Oceanography, 6: 175-181.
AL-Moghrabi, S., Allemand, D., and Jaubert, J. 1993. Valine upgrade by the scleractinian coral Galaxea fascicularis characterization and effect of light and nutritional status. Journal of Comparative Physiology B, 163: 355-362.
Grover, R., Maguer, J., Allemand, D., and Ferrier-Pages, C. 2006. Urea uptake by the scleractinian coral Stylophora pistillata. Journal of Experimental Marine Biology, 332: 216-225.
Wilkinson, C. 2004. Status of Coral Reefs of the World Report. Available from: http://www.aims.gov.au.
Cesar, H. 2000. Ed. in Collected Essays on the Economics of Coral Reef. CORDIO: Sweden.
Precht, W. 2006. Ed. in Coral Reef Restoration Handbook, Boca Raton. CRC Press.
Job, S., Schrimm, M. and Morancy, R. 2003. Reef Restoration: Practical guide for management and decision-making Carex Environnement, Ministère de l'Écologie et du Développement Durable, IFRECOR.
Omori, M. and Fujiwara, S. 2004. Ed. in Manual for restoration and remediation of coral reefs. Nature Conservation Bureau, Japan: Ministry of Environment:1-84.
Epstein, N., Bak, R. and Rinkevich, B. 2003. Applying forest restoration principles to coral reef rehabilitation. Aquatic. Conservation, 13: 387-395.
Simenstad, C., Reed, D. and Ford, M. 2006. When is restoration not? Incorporating landscape-scale processes to restore self-sustaining ecosystems in coastal wetland restoration. Ecological Engineering, 26: 27-39.
Elliott, M., Burdon, D., Hemingway, K., and Apitz, S. 2007. Estuarine, coastal and marine ecosystem restoration: confusing management and science—A revision of concepts, estuarine. Coastal and Shelf Science, 74: 349-366.

### Federally Sponsored Research

This project was supported, in part, by a grant from the National Science Foundation.

### Joint Research Agreement

This work was conducted by faculty and students at Valdosta State University, a component of the University System of Georgia. MIC Systems Inc. (Valdosta, Ga.) assisted in supporting the efforts of the PI. Only the parties of Valdosta State University (Valdosta, Ga., USA) and the University System of Georgia (Atlanta, Ga., USA) claim the intellectual property outlined in this application.

### FIELD OF INVENTION

The current invention relates to a mineral based composition that effectively grows organisms in a marine environment. The mineral based material is composed of both organic and inorganic components that provide a surface for nucleation to take place that is capable of sustaining an ecosystem that reflects the diversity of life seen in the area.

### BRIEF SUMMARY

This invention involves a method to produce concrete that is used as both a surface and a nutrient source for marine life to nucleate and grow. The construction includes both organic and inorganic nutrients that slowly leach from the concrete into the marine environment. Care is taken in selecting the materials needed for the composition of the concrete. For example, slags and ashes can produce a concrete that has extremes in acidity, basicity or toxicity. Calcium carbonate and other carbonate minerals not only serve as a pH buffer but also provide needed carbonates that are released at a slow rate for organisms such as oysters, corals and bryozoans. Most concrete construction inventions focus on making the strongest possible material for use in building structures. The concrete described in this invention is designed to slowly degrade, releasing its nutrients and eventually resulting in a natural mineral deposit (i.e. silicates and carbonates) on the ocean floor, leaving a thriving marine ecosystem in its place.

### BACKGROUND OF THE INVENTION

Many inventions and discoveries have been revealed that examine or utilize different materials and surfaces for the growth of life in fresh and salt water environments. These materials have included car tires, automobiles, trains, planes, ships, bridges, building debris, fly ash, rocks and shells. In most of these cases, there is no strategy by the designer to provide a specific organism an advantageous surface that includes the correct nutrient composition, provides a proper shelter, or has the correct chemical parameters needed such as pH, redox potential, ionic strength and dissolved oxygen levels at the surface-water interface.

Mussels are a type of shellfish that adhere to a range of structures including rocks. The glue that holds mussels to the rock is composed of DOPA proteins. These proteins draw on the mussel but can also draw on a bacterial film that is present on the surface. These proteins take part in the mussel's adhesion process to a surface that involves both iron and silicates. In order to maximize the adhesion and growth of the mussel to a surface, a source of sugar should be available to start a bacterial biofilm, both iron and silicates should be present on the surface for adhesion, and amino acids should be available in the matrix to contribute to the growth of the binding protein. In addition, chemical species including amino acids, vitamins, trace minerals and starches, which are all needed to support life in the earliest stages, should be available in sufficient quantities. A strategy for growing mussels should then include the slow release of many of these species to help them survive and prosper.

A coral's nutrient cycle can be complex and draw on several sources. One such source that corals draw on is dissolved organic matter (DOM) which is a brood of chemicals that includes sugars, amino acids, urea, carbohydrates and functionalized hydrocarbons (i.e. stearic and palmatic acid). Corals rely heavily on trace levels of these species from the surrounding water supply, including over a dozen amino acids. The energy source for many corals is derived from zooxanthellae (algae prominent on coral reefs) photosynthesis. This process would require some nutrients to help the photosynthetic algae to grow as well as a steady supply of carbon dioxide to produce carbohydrates in a complex cycle. Corals also require dissolved inorganic matter which can be delivered as nanoparticles and include species such as calcium, magnesium, copper and iron at appropriate concentrations. There must also be some flexibility in designing the structure if specific species of corals are being cultivated. For example, most gorgonians have a large fan-shape configuration and are perpendicular to the local water currents and tidal flows. With the correct geometry, the gorgonians can catch plankton from the water supply more efficiently. While this outlines some of the parameters in effectively growing corals, a process needs to take into account the slow release of specific chemicals, both organic and inorganic, as well as the restriction of other chemical species. For instance, corals are very sensitive to species such as chromium, so a steel object (i.e. train or ship) that typically contains over ten percent chromium will leach the toxic species over time and therefore minimize the growth of specific coral species. Another example is the overuse of phosphate which can encourage the growth of certain species of algae that then coat corals and prevents their growth. In designing a surface with slow releasing chemical species, it is important to select to include and not include certain species to optimize the growth rate of corals.

Another example of a carbonate based marine organism that benefits from this invention is the oyster. Specific species such as the Crassostrea gigas (Pacific Oysters), Crassostrea sikamea (Kumamoto Oysters), Crassostrea virginicas (Atlantic Oysters), Ostrea edulis (European Flats), and Ostrea lurida or Ostrea conchapila (Olympia Oysters) can benefit from this technology. While oysters are known as a food source, they also provide tremendous advantages in natural ecosystems as well as to humans. For example, oyster beds can help stabilize a shoreline and prevent erosion. There are many examples of using oyster colonies to save existing property from being engulfed by the sea. Oyster colonies can also play a tremendous role in maintaining clean water. A single adult oyster can filter up to fifty gallons of water per day, removing various unwanted microbes and chemicals.

Oyster beds have been destroyed by human intrusion through dredging, excessive fertilizer use, over-harvesting, herbicides and pesticides that run off into the ocean, accidental ship groundings, freshwater flow shortages, oil spills and disease. Replacing or extending these oyster beds, which may stretch many miles, is a monumental task. A technique is needed that is economical and applies the concepts of green technology to replenish these oyster bars since they continue to decrease in size or have been completely destroyed. Currently, repurposed oyster shells are collected and dispersed to serve as a medium for new oyster larvae, or spat, to settle on and grow. This approach has not only exhausted many of the oyster shell reserves making them less available, but it has also led to an increase in their price. Other approaches include utilizing large cement structures that can weigh between five hundred and two thousand pounds to serve as a surface for oyster growth; however, this approach is limited for two reasons. First, oysters often live in shallow waters and the large cement structures must be transported to deeper water locations using a barge with a crane to operate successfully. Second, once these structures are put in place, they are difficult or impossible to relocate if needed. In many cases, an approach where a surface can be placed near an existing oyster bar to colonize the spat and then be moved to another area is necessary to rejuvenate an oyster population. This would require a small, easily deployable and transportable device. Even in deeper water, economics would limit reintroducing an oyster bar if just large, expensive structures were used.

Another field to be considered when placing a bioactive material in the ocean is biofilms and the potential drugs they can produce. Currently, many drugs that are harvested from the ocean are produced by symbiotic bacteria that reside within a host organism. There are a plethora of examples: ara-A extracted from a marine sponge is an antiviral drug, ara-C extracted from a marine sponge is an anticancer drug, cephalosporins from a marine fungi are an antibiotic, conotoxins extracted from Cone snails are used for chronic pain, GTS21 extracted from a Nemertine worm is used for Alzheimer's disease, LAF389 extracted from a sponge is a cancer drug, Yondelis (ET743) extracted from a sea squirt is used against soft tissue sarcoma, dolastatin-10 extracted from a sea slug is used against cancer, ILX651 from a sea slug is used to battle cancer, cemadotin extracted from a sea slug is used against cancer, discodermolide extracted from a deep ocean sponge is used against cancer, IHTI286 extracted from a sponge is used to treat cancer, aplidin extracted from a sea squirt is used to battle cancer, and Bryostatin-1 from a bryozoan is used as a medication in cancer, HIV and Alzheimer's diseases. These drugs provide some insight to the proliferation of medicines that have been identified from marine life over recent decades. These drugs are identified in their host organisms at very low concentrations (i.e. 10⁻⁷ to 10⁻⁸ percent)making them available in extremely limited quantities. In most cases, these host organisms are incapable of supplying the significant quantities needed for medicinal applications. A surface that provides nutrients to grow bacterial films, for either surveying an ecosystem for new pharmaceutical agents or for producing known agents, would be a significant improvement over existing methods.

### DETAILED DESCRIPTION

This invention focuses on a process to make a solid, mineral-based, bioactive structure that can serve as a nucleation point for a host of marine life. The process involves mixing together a series of compounds to form a final composition that will harden and provide a source of nutrients for feeding. Products found in the cement and final concrete mixture include calcium oxide (CaO), silicon dioxide (SiO₂), aluminum oxide (Al₂O₃), iron oxide (Fe₂O₃), magnesium oxide (MgO), diphosphorous pentaoxide, sulfur trioxide, tricalcium aluminate (Ca₃Al₂O₆), tetracalcium aluminoferrite (Ca₄Al₂Fe₂O₁₀), dicalcium silicate (Ca₂SiO₅C₂S₂₀), tricalcium silicate (Ca₃SiO₄ C₃S₅₅), sodium oxide (Na₂O), potassium oxide (K₂O), gypsum (CaSO₄.2H₂O), and calcium carbonate (CaCO₃). Depending on the reactants used and the conditions present in the kiln, the qualitative and quantitative composition of the products can vary. These are normal components of concrete that are routinely mixed in various proportions to optimize different parameters. Concrete composed of these materials can, by itself, be a very poor surface to serve as a nucleation point for marine life. For example, reacting sulfur trioxide with water produces sulfuric acid resulting in a pH that would minimize the ability of organisms to thrive on the surface. Various types of slags and fly ash can also produce a chemical environment incapable of sustaining life. Additional chemical species are added to optimize surface conditions, such as pH, and to provide a slow release of key nutrients essential for life.

In this process, many nutrient and chemical species are added to optimize surface conditions which include: calcium carbonate, cellulose, sugars (i.e. sucrose, glucose, fructose, etc.), sodium bicarbonate, proteins, peptides, chitin, lignin, urea, ammonia and/or ammonium, sodium oxide, potassium oxide, iron oxide, potassium, sulfate, magnesium, strontium, phosphate, nitrate, nitrite, silicates, boron, copper, iron, manganese, molybdenum, zinc, vitamin A, vitamin D, glutamic acid, aspartic acid, leucine, lysine, proline, threonine, isoleucine, valine, serine, alanine, tyrosine, methionine, arginine, phenylalanine, tryptophan, glycine, histidine, vitamin C, vitamin E, niacin, magnesium, thiamin (B1), riboflavin (B2), vitamin B6, pantothenic acid, vitamin K, folic acid, biotin, vitamin B 12, iodine/iodide, selenium, chromium, tin, vanadium, lithium, barium, nickel, cadmium, lead, cobalt, silver, and titanium. Many of these species, such as lithium, chromium, sulphate and nitrate are part of various salts and can contain a charge. Some of these species, such as the vitamins and amino acids, are added in at trace levels.

In this process, the bulk components—lime or calcium oxide, silica, alumina, iron oxide, gypsum, and calcium carbonate—are placed in a container. Typically, they are obtained by mixing Portland cement with limestone sand and silica based sand. The remaining components, each present at lower than one percent of the total mass, are mixed with water. The water volume used to dissolve or suspend the trace species (in milliliters) is typically twenty percent of the bulk components mass (in grams). For example, if the bulk components weigh one kilogram or one thousand grams, then two hundred milliliters of water is used to dissolve and solubilize the remaining species, many of which are nutrients. This chemically enriched solution is then added and mixed in with the bulk material. Additional water is added until the material reaches a proper texture where it will dry and harden.

This nutrient enriched concrete mixture is poured into a mold and allowed to dry. In this work, the exact composition can vary according to physical and chemical conditions as well as the marine organism that is sought during the grow-out process. For example, when growing oysters or corals, organisms that have a high demand for calcium carbonate, a significant part of the additives to the cement in its transition to concrete is limestone dust. Likewise, scientific studies have shown that corals are very dependent on twelve specific amino acids for their growth; subsequently, these make up about 0.0003% of the final concrete mixture by mass percentage. Similarly, some chemicals are minimized to remove unwanted growth. For instance, the addition of high levels of phosphate can result in high growth rates of unwanted algae that can coat the cement material with a green matt preventing other species, such as corals, from nucleating to the surface and growing. In many cases, concrete mixtures can result in a material that has a high or low pH which is the result of additives such as fly ash. In our mixture, an amphiprotic species such as sodium bicarbonate is added to serve as a buffer. As the concrete saturates, the electrolyte dissociates and forms inert sodium ions and bicarbonate ions. The bicarbonate ions quickly pick up a hydrogen ion or neutralize hydroxide ions; this serves as a buffer and maintains the pH of the surface in the 6-8 range which is the condition needed for living creatures to survive. The actual pH can be fine-tuned to be slightly acidic or slightly basic, as required by a specific organism.

Iron levels and the form that iron is delivered in can be important for various marine organisms. Iron is often contained in cement in relatively high concentrations as insoluble iron oxide. This form can be very difficult or impossible for most marine creatures to dissolve and consume. Iron is a limiting nutrient in the marine environment, so its availability is critical for the survival of many life forms. Given these conditions, iron may be added to concrete mixtures as a salt (i.e. iron (III) chloride) or in a complex (i.e. iron-hemogloblin) so that it can be used by marine species.

Sugars can be delivered in different forms such as mono, di and trisaccharides. Higher quantities of sugar can be used to trigger the rapid growth of biofilms that are composed largely of bacteria. These biofilms are of great use in searching the ocean for marine natural products or drugs that come from the sea. Bacterial biofilms are also a food source for many marine creatures of higher trophic levels and can serve as a starting point for an ecosystem.

Natural polymers such as cellulose, starch, lignin and chitin can be added to serve as an organic nutrient as well as a material to slightly weaken the concrete contributing to its ability to biodegrade over time. The state and condition of these compounds can also be important. For example, in some grow-outs, some fresh (green) pine needles were ground up and added to a mixture at approximately 0-2% of the total mass. In addition to cellulose and lignin present in the pine needles, the material contained potential nutrients such as chlorophyll, sap and cell components. In another example, fresh chitin from shrimp shells were ground up and added at a low total mass percent (approximately 0.1%). When added, the chitin was covered with a bacterial film that was incorporated into the nutrient enriched concrete giving it an additional component that contributed to its bioactivity.

There are additional considerations when making a nutrient enriched concrete. While there are a host of organic type molecules that serve as nutrients, they can also weaken the concrete structure which enhances its ability to biodegrade. Many concretes made for typical industrial purposes, such as for buildings and large pipes, desire strong, long-lasting concrete. In this invention, the concrete is designed to eventually biodegrade and leave behind a natural residue composed of common minerals such as silica, alumina and carbonates. This degradation is designed to last over several years. If organics are added at high concentrations, then the concrete will either decay too quickly in the marine environment or will produce a material that will not hold its form at all. The concentration of the more economical organic species, such as the sugars, is typically kept below 0.3% of the total mass.

Some chemical species are required at trace levels in order for life to be sustained. These include species such as copper and manganese. These species can also be toxic at higher concentrations to many forms of life. Their levels in the final concrete structure are on the order of tens of parts per million providing an essential nutrient that is below toxic levels.

Another important factor for nucleating and raising some marine species, particularly in their early phases of life, is protection. These concrete structures are often designed with grooves and small holes that provide a safe location for microscopic larvae, such as for corals or oysters, to begin their life cycle. Marine predators such as fish and crabs will often scour a surface for food, such as larvae, impacting the production of a species. Holes, grooves and crevices give larvae a chance to nucleate and grow to a size where they cannot be easily consumed.

In a typical composition of this invention, nutrients comprise the mass percentages as follows: 100 parts Portland cement, 35 parts calcium carbonate sand, 2 parts silica based sand, 2 parts sodium bicarbonate, 0.01 parts sum total of sugars, 0.01 parts sum total of vitamins, 0.005 parts sum total of essential amino acids, 0.01 parts sum total of nitrate, ammonium and phosphate, 0.1 parts sea salts, 0.1 parts cellulose and chitin, 0.001 parts starch, and 0.001 parts total iron, copper and zinc chloride.

What is claimed is:

1) A method of forming a nutrient enriched concrete mixture with water in which the hydroxide ion concentration is below 0.001 Molar and the hydronium ion concentration is above 0.001 Molar in the aqueous suspension, and it contains a suspended and dissolved bulk inorganic composition, a trace inorganic composition, and a trace organic composition.

2) The method of claim 1 where carbonate and/or bicarbonate components, considered a bulk constituent, comprises at least one percent of the total solid mass.

3) The method of claim 1 where additional inorganic minerals and salts are composed of silicates such as but limited to silicon dioxide and silicon trioxide, aluminates such as but not limited to aluminum oxide, oxides of alkaline earth metals such as but not limited to calcium oxide and magnesium oxide, and additional soluble and insoluble salts that contain hydroxides, water molecules, chlorides, sodium ions, potassium ions, calcium ions, sulfate ions, magnesium ions, iron ions, and fluoride ions; the sum of these species total at least thirty percent of the total final mass.

4) The method of claim 1 where salts of transition metals such as but not limited to zinc, copper, manganese, molybdenum, silver, lead, boron, and cobalt total at least one part per million by mass of the dried concrete.

5) The method of claim 1 where salts of inorganic anions such as but not limited to nitrates, nitrites, ammonium, phosphates, sulfides, iodides, bromides, sulfites total at least one part per million by mass.

6) The method of claim 1 where salts of other cations such as but not limited to lithium, barium, strontium, tin and selenium total at least ten parts per billion of the total concrete mass.

7) The method of claim 1 where a mixture of vitamins may contain one or more of the following species: vitamin A, vitamin C, vitamin D, vitamin E, vitamin K, thiamin(B1), riboflavin(B2), niacin, vitamin B6, folic acid, vitamin B12, biotin, and pantothenic acid total at least one part per million by mass.

8) The method of claim 1 where a mixture of amino acids may contain one or more of the following: glutamic acid, aspartic acid, leucine, lysine, proline, threonine, isoleucine, valine, serine, alanine, tyrosine, methionine, arginine, phenylalanine, tryptophan, glycine, and histidine total at least one part per million by mass.

9) The method of claim 1 where a natural source of cellulose and lignin are included in the final concrete mixture and total at least one part per million by mass.

10) The method of claim 1 where a protein source, such as but not limited to albumin, is included in the final concrete mixture and totals at least one hundred parts per billion by mass.

11) The method of claim 1 where the natural polymer chitin is included at a mass percent concentration of at least one parts per million.

12) The method of claim 1 where urea is included in the concrete mixture and has a total mass percent concentration of at least ten parts per billion.

13) The method of claim 1 where marine microbes such as bacteria may be included in the mixture increasing the bioactivity of the final concrete mixture.

14) The method of claim 1 where there is a sugar source, typically a combination of monosaccharide's, disaccharides and trisaccharides, is included in the concrete mixture and totals at least one part per million by mass.

15) The method of claim 1 where the function of adding chemical species such amino acids, vitamins, sugars, proteins, urea, citric acid, trace elements, etc. is to serve as nutrients for the growth of marine life.

16) The method of claim 1 where the addition of nutrients serves to decrease the strength of the concrete allowing it to slowly degrade leaving behind inert chemical species such as silicates, aluminates and carbonates that are naturally found in nature.

17) The method of claim 1 where incorporating organic and inorganic nutrients essential for life results in the slow and controlled release of these species over an extended period of time.

18) The method of claim 1 where the chemical species selected are mixed with cement to form concrete and deployed in the environment in such a procedure as to qualify as a green technology with a particular emphasis on the practices of sustainability.
